(19) United States
(12) Patent Application Publication
(10) Pub. No.: US 2003/0187709 A1
(43) Pub. Date: Oct. 2, 2003

(54) Adaptive enterprise optimization (AEO) framework and methods

(75) Inventors: Alexander Brodsky, Rockville, MD (US); John King, Fairfax, VA (US); Xiaoyang Wang, Fairfax, VA (US)

Correspondence Address: BLANK ROME LLP, 600 NEW HAMPSHIRE AVENUE, N.W., WASHINGTON, DC, 20037, US

(73) Assignee: Adaptive Trade, Inc.

(21) Appl. No.: 10/372,407

(22) Filed: Feb. 25, 2003

Related U.S. Application Data
(60) Provisional application No. 60/358,720, filed on Feb. 25, 2002.

(51) Int. Cl. G06F 17/60

(52) U.S. Cl. 705/7

(57) ABSTRACT

The Adaptive Enterprise Optimization (AEO) server allows users to model their individual business entities or parts of the value chain through and to model their decision/optimization problems based on these business entities. This is done using a high level modeling language. Based on the models and user input data, the AEO server is able to automatically generate appropriate global optimization problems, and solve them using advanced mathematical programming and constraint database programming technologies.

### REFERENCE TO RELATED APPLICATIONS

The present application claims the benefit of U.S. Provisional Application No. 60/358,720, filed Feb. 25, 2002. Related subject matter is disclosed in three commonly assigned PCT international patent applications published as WO 01/031537 A2, WO 01/033401 A2, and WO 01/33400 A2. The subject matter of all of the above-cited applications is hereby incorporated by reference in its entirety into the present disclosure.

### FIELD OF THE INVENTION

The present invention relates to a computer-based technique for allowing business users make optimal business decisions in such areas as operations, sourcing, manufacturing, transportation, and collaborative supply networks.

### DESCRIPTION OF RELATED ART

In the traditional optimization solutions, global optimization models, which involve mathematical constraints (e.g., equations and inequalities) and the objective function are built manually by operations research experts, and are hard-wired to the problem at hand. Typical solutions are “black-box” and thus are difficult to change or customize, and typically require re-implementing a solution from scratch. traditional optimization solutions make multiple simplifying assumptions to be able to implement complex global models.

### SUMMARY OF THE INVENTION

It is therefore an object of the present invention to overcome the above-noted deficiencies of the prior art. It is another object of the invention to provide a Business Entity Model and Decision Model system for use in the Enterprise Optimization realm.

To achieve the above and other objects, the Adaptive Enterprise Optimization (AEO) server allows users to model their individual business entities or parts of the value chain through and to model their decision/optimization problems based on these business entities. This is done using a high level modeling language. Based on the models and user input data, the AEO server is able to automatically generate appropriate global optimization problems, and solve them using advanced mathematical programming and constraint database programming technologies.

AEO BEM and DM is Quickly Deployable, Customizable, and Extensible—Only AEO BEM and DM technology allows companies to quickly integrate factors from across the enterprise (such as finance, manufacturing, sales, transportation) into decisions. Fast modeling capability makes it easy to extend the improved decision tools to multiple organizations and enables rapid deployment throughout an enterprise.

Run-time Modeling of Business Situations—AEO BEM and DM technology doesn't use a fixed set of static models like other solutions, because every time a critical business decision is made, it must be based on all of the factors and most current information available. The technology is a real-time decision optimization engine that incorporates the complex interactions of diverse business resources, their specific factors and constraints, and dynamic market conditions. It has the ability to analyze a business situation and dynamically build an enterprise business model “at run-time” is a big technical challenge. The recommendations produced by the system are based on the best and most current information available at the time of the decision. This can significantly improve decision speed and accuracy.

Optimizes Using Very Large Amounts of Data—AEO BEM and DM technology is designed for today's business environment, where scenarios can involve very large amounts of data supplied from internal and external sources. These data can define a problem space that contains hundreds of thousands, if not millions, or alternatives. Only AEO BEM and DM technology can scale to handle problems of this magnitude and still develop recommendations quickly enough to be useful in today's dynamic business environment.

Optimal Impact on Business Measures of Success—Many optimization tools on the market today can provide recommendations to optimize profit, revenue, or other business objectives for a particular business unit or individual resource, such as a plant. However, these narrowly focused recommendations don't guarantee that the overall corporate profit objectives are met, in fact, sometimes they do just the opposite. Only AEO BEM and DM technology can take into account a broad enough set of business resource models, factors, and constraints to ensure that the appropriate recommendations are being made to achieve the corporate business objectives.

The present invention differs from the prior art in the following respects.

1. The proposed Adaptive Enterprise Optimization (AEO) Framework and Methods allow business users make optimal business decisions in such areas as operations, sourcing, manufacturing, transportation, and collaborative supply networks. Those decisions are based on the proposed methods of Business Entity Models (BEM), that model such supply network entities as suppliers, manufacturers, transportation services, financial services, customers, packaging, financial instruments, as well as physical equipment used in a supply network. The decisions are driven by proposed methods of Decision Models (DM), that model the objective function, such as minimizing operation costs or maximizing revenue or profit, and global constraints, which often reflect global demand and supply requirements and limitations.

2. Key differentiation of the proposed AEO Framework and Methods from the traditional optimization solutions is as follows. In the traditional optimization solutions, global optimization models, which involve mathematical constraints (e.g., equations and inequalities) and the objective function are built manually by operations research experts, and are hard-wired to the problem at hand. Opposite to this, AEO Framework and Methods allow to easily build modular models (BEMs and DMs), which are defined by the user, whereas global optimization models are constructed automatically at run time, from simple components, which are instances of BEMs (representing actual business entities available to the enterprise) and DMs.

3. Because of the modular architecture of AEO, new business rules and factors can easily be added (via instances of existing BEMs, or new BEMs), without changing any previously built BEMs or DMs. This is opposite to typical operations research solutions, which are “black-box” and thus are difficult to change or customize, and typically require re-implementing a solution from scratch.

4. Using the proposed AEO Framework and Methods, the users do not need to make simplifying assumptions about the enterprise being optimized. This is due to relative simplicity of local models (BEMs and DMs). In contrast, traditional optimization solutions make multiple simplifying assumptions to be able to implement complex global models.

5. The proposed AEO Framework and Methods allow business users to perform enterprise-wide optimization, e.g., profitability, considering simultaneously all factor affecting the enterprise decision making. In contrast, traditional optimization solutions are often simplified with a series of silo optimizations, which results in less than optimal results.

6. The proposed AEO Framework and Methods allow business users to describe their models (DMs) in business level terms, such as price, cost, revenue, profit, which are easily understood, without the need to understand the mathematical complexity of each business entity. This is in contrast to the hard-wired optimization models, which are described in mathematical, rather than business terms, and thus require users to have significant operations research expertise, rather than common sense business knowledge.

7. The proposed AEO Framework and methods allow business users to share Business Entity Models (BEM) across multiple decision optimization solutions, without any change in existing BEMs. Similar, they allow to extend and existing decision model (DM) by letting it consider additional BEM's, without any change to the DM.

8. Because of points 4 and 5, the proposed AEO Framework and Methods provide business users with better, i.e., more optimized solutions to the optimization problem at hand.

9. Because of points 2, 3, 6 and 7, the proposed AEO Framework and Methods allow developers faster implementation time, and less resources necessary, as compared with traditional optimization solutions approaches.

10. Also because of points 2,3,6 and 7, the proposed AEO Framework and Methods allow developers easier maintenance and enhancement of optimization solutions, thus saving time and money.

11. AEO methods can be split into 3 categories: Resource Model methods, Business Entity Model (BEM) methods, and Decision Model (DM) methods.

The present disclosure describes the conceptual AEO model, including the conceptual business entity model (BEM) and decision model (DM). We described the exact semantics of these models and their instances, and provide a formal semantics of the associated global optimization problem.

We start with the description of Resource Match Specification (RMS), which is a formal description of resources within business entities and rules by which they match. Resources form basic “units” in AEO models. We then present the concept of a Business Entity Model (BEM), which is basically a bundle of related resources consumed and produced by a business entity, as well as constraints connecting resources and relevant business metrics. These two concepts form the basic description of the enterprise. With these formal descriptions of the enterprise, we then intruduce the notion of a Decision Model (DM), which is a formal description of an global optimization/decision support problem of the enterprise described through its BEM's. We then describe the precise semantics of Decision Instances relative to the relevant Business Entity Instances present in the AEO server and the corresponding optimization methods. In the description of models, we use some basic terminology of object-oriented programming, including the notions of classes and class instances (or objects).

### BRIEF DESCRIPTION OF THE DRAWINGS

A preferred embodiment and various examples will be set forth in detail with reference to the drawings, in which:

FIG. 1 AEO BEM and DM Class Diagram, presents a high level graphical summary of the Adaptive Enterprise Optimization Business Entity Model and Decision Model classes.

FIG. 2 Functional Diagram of AEO BEM and DM, presents a high level graphical summary of the Methods used by the system.

FIG. 3 shows a match map with contract variables.

FIG. 4 shows a graph of a decision model.

FIG. 5 and FIG. 6 show class diagrams of the AEO framework.

### DETAILED DESCRIPTION OF THE PREFERRED EMBODIMENT

A preferred embdodiment and examples thereof will be set forth in detail with reference to the drawings and also with reference to the following terms, acronyms, and abbreviations.

| Terms/Acronym/Abbreviation | Detailed Explanation |
|---|---|
| Business Entity | Entity of business in the enterprise that is |
| | viewed as an inseparable entity for the |
| | optimization/decision support purpose. |
| BEM | Business Entity Model: a formal |
| | specification for a type of business entity |
| BEI | Business Entity Instance: an instance of |
| | business entity defined by a BEM |
| Resources | A resource of a business entity that is |
| | involved in the decision/optimization |
| | problem. Two types of resources: input |
| | and output. |
| RMS | Resource Matching Specification: formal |
| | specification of how resources |
| | match against each other. |
| | Input resources only match with output |
| | resources and vice versa. |
| DM | Decision model: a formal specification |
| | of a type decision/optimization problem |
| DI | Decision instance: an instance of the type |
| | defined by a DM |
| Constraint | A mathematical formula that bounds the |
| | values of some variables |
| Variable | An unknown, or a placeholder that may |
| | take on values (usually, values are limited |
| | by constraints) |
| Match map | A map that shows the connection (or |
| | match) between resources of involved |
| | BEIs. |

First, the fundamental elements that compose the Adaptive Enterprise Optimization (AEO) Framework will be disclosed. These elements include Resources, Business Entities, and Decision Instances. These elements are discussed in detail here as well as the semantics of an AEO Optimization, in which the elements participate. Also included is the description of software realization of these elements in the AEO framework.

Generally speaking, a business entity corresponding to an independent unit of business within the enterprise that encapsulates a set of resources. A decision instance is a mechanism that connects the business entities, along with their resources, to form a decision problem and obtain optimization decision or solution to a business problem.

Resources are basic units of business entities in an enterprise or a value chain. A resource may be a physical resource (e.g., when a producer is producing a physical resource) or a “virtual” resource (e.g., when the resource is actually some services or concepts). Resources can also be “existing” (in the sense that a producer does have the resource) or “required” (in the sense that a “consumer” is looking for the resource that may or may not exist). In the AEO framework, there is no distinction between these different kinds of resources; they are all resources.

Each resource must fall into a standard “domain” so that business participants can understand the resource being offered or being sought. For example, when a resource is output for potential “consumers”, the type of the resource, such as “a resistor,” must be mentioned to inform potential consumers. This “type” information actually determines some “standard” (or “agreed upon”) specification of the resource. For example, “resistance” can be part of the specification of a resistor. Such specifications must be agreed by every participant in order to match up the resources for the proper operation of the enterprise.

The notion of Resource Match Specifications (RMS) is to formalize the above “standards”. Conceptually, each resource type is associated with exactly one RMS, and all resources associated with a particular RMS use the same Resource Specification class to describe itself, as well as the same set of constraint variables to describe contractual terms. These two aspects are essential for the AEO server to have to ability of modular and encapsulated modeling. We now describe these two aspects of RMS in more detail.

Resource specification (Resource spec) is a static description of a resource. For each RMS, there exist a number of classes (or abstract data types) that serve as the “type” information of resource specifications in the RMS. For example, a resource spec class may allow a description of a resource based on Attribute-Value pairs, e.g.:

| | |
|---|---|
| Resistance | 0.5 |
| Temperature Range | −50-−140 |
| Vendor | ABC |

We will discuss two specific classes for Resource Specification below.

In the same RMS, resources are partitioned into two kinds, namely input resources and output resources. Business entities, to be discussed in detail in later sections, may produce many different types of output resources and may require many different types of input resources.

The purpose of Resource Specs is to provide resource data that is sufficient to determine whether or not two resources match. This is captured by the is-Output-Input-Match() method, which is contained in each RMS class:

Boolean isOutputInputMatch( Output: ResourceSpec, Input: ResourceSpec)

This method tells whether two ResourceSpecs, of Output and Input resources in the same RMS have matching specs or not. The two resources are usually from a “producer” and a “consumer” of the resource, respectively, and the match method (as agreed by all business entities in the enterprise) tells if the “producer” produces something (Output resource) that satisfies the “consumer's” requirement (Input resource).

RMclasses is extensible. Examples include SKU-based-RMS, Exact-Match-RMS, and More-General-More-SpecificRMS. We discuss specific RMS classes in more detail below.

The method isOutputInputMatch() is generalized to the case when the two ResourceSpecs do not necessarily belong to the same RMS class. Applied to Output and Input ResourceSpecs, it works as follows. If Output and Input ResourceSpecs do not belong to the same RMS, OutputInputMatch returns FALSE. Otherwise, if they belong to the same RMS class X, the OutputInputMatch method of class X is used to return its Boolean value. The generalized OutputInputMatch method appears in a special class called RMSDispatcher.

A resource specification describes the corresponding resource. This specification is useful, for example, to see if a producer can satisfy a consumer with a particular resource it produces. This we may call it the “non-negotiable” part of the resource. For example, if a consumer wants a resistor, the consumer usually specifies the resistance needed, and this is not subject to negotiation. If the producer does not have the matching resource (resistor) with the right resistance, then the producer cannot satisfy the consumer's requirement.

The other aspects of resource match-up involve “negotiation parameters”. For example, the quantity may be a negotiable aspect of a resource match up. When an enterprise-level plan/schedule is decided, quantity needs to be settled. In this example, the quantity of resistors needs to be set up to achieve an optimal solution to the enterprise level decision/optimization problem. In other words, this quantity value should be decided not by the business entity. Instead, it should be decided when the enterprise-level decision is made.

Because of the above reason, we introduce the concept of contract variables. For each RMS, there is a fixed set of contract variables (so that each business entity that deals with resources in the RMS understands the semantics of each contract variable).

The separation in the AEO model between resource spec and contract variables is as follows: Resource specs are used to tell if a producer resource satisfies a consumer resource (requirement), while contract variables acquire values (or “are instantiated”) as the result of an enterprise-level “negotiation” or optimization (automatically done in the AEO server through match making and optimization, whose exact semantics are described later).

In order to facilitate automatic “negotiation” or optimization, each resource needs to give some restrictions to or constraints on its instantiation of contract variables. Indeed, a producer usually does not have unlimited quantity of a resource to offer, and a consumer does not usually need arbitrary quantity. The same applies to the other variables. Any solution to the enterprise-level optimization problem must satisfy all the constraints that the participants put on all the contract variables of all the resources (this is described more precisely later).

Consider now the kinds of constraints a resource may place upon contract variables. A consumer may want 10 units of a particular transistor. A natural constraint on the quantity variable is to force it to be 10, in formula, we say “quantity==10”. However, one producer may have 6 pieces of this particular transistor, while another producer has 7 more. In this case, the natural constraints for producer 1 is “quantity==5” and for producer 2 is “quantity==7”. It is now clear that it is impossible to have a value for quantity that satisfies all the constraints (one from the consumer and two from the two producers, respectively).

A closer inspection yields that a producer may want to output any quantity as long as the total quantity does not exceed a certain number, and a consumer may want to buy any quantity from a particular producer as long as the total quantity is exactly what's required.

This observation gives rise to two parts of the constraints to resources: namely qualifying and composition constraints. In the above example, for the consumer, the qualifying constraint can be 0<=quantity<=10 (i.e., can buy from any particular producer 0 to 10 pieces of the resource), and the composition constraint is “summation of the quantities from all the trading partners must exactly be 10”. The first producer's qualifying constraint is 0<=quantity<=6, and the composition constraint is “summation of the quantities sold to all trading partners must not be more than 6”. Likewise, the second producer's qualifying constraint is 0<=quantity<=5, and the composition constraint is “summation of the quantities sold to all trading partners must not be more than 5”.

Following the above observation, we can now derive the constraint for a trade at the level of resources. At the resource level, one output resource may match a number of input resources, and one input resource may match a number of output resources. As mentioned earlier, each pair of matching resources must belong to the same RMS. An example of such resource level matching can be shown in FIG. 1.

In FIG. 1, the first resource (RS₁) is (the requirement of some) truckloads of transistors (of a consumer), and the second resource (RS₂) is (the requirement of some) delivery service. The third resource (RS₃) is a money resource that pays for the goods (transistors) and services (trucking). Resource RS₄ are the transistors that a vendor is selling, and RS₆ is (the requirement of some) money resource that the vendor wants to receive. RS₇ is the transportation service resource (of a trucking company) and RS₈ is (the requirement of) money resource that the trucking company wants to receive. Assume that the contract variables for the transistors are quantity and price, for money is amount, and for transportation is weight and price.

For each pair of resources in the match scenario, there is a potential “trade”. A particular pair-wise trade needs to satisfy the qualifying constraint (on contract variables) of both resources involved in this pair-wise trade. Different pairs of resources need to use different instantiations of the contract variables to distinguish the individual pairs. For example, the pairs (RS₃, RS₆) and (RS₃, RS₈) use different instantiations of the variable amount. In the AEO framework, we use the IDs of the resources to instantiate variables. Thus, we will use amount[RS₃,RS₆] and amount[RS₃,RS₈] on the two pairs of resources. Resources RS₃ and RS₆ will build respective qualifying constraints on amount[RS₃,RS₆], and resources RS₃ and RS₈ will build respective qualifying constraints on amount[RS₃,RS₈]. For other pairs of match, corresponding qualifying constraints will be built similarly.

For each resource, a composition constraint will be built based on the matching scenario. It will be build with all the instantiations of the contract variables that are on all the “connections” in which it participates. For example, the composition constraint for RS₃ will be using the instantiations of the contract variables on amount[RS₃,RS₆] and amount[RS₃,RS₈].

To use more concrete example, we assume that the requirement of transistors of the procurer (RS₁) is 3 (truckloads), but the procurer is only willing to pay up to $10,000 (i.e., RS₃ has a limit), including the trucking service (RS₂). Assume further that the vendor has 100 (truckloads) of transistors (RS₄), and each (truckload) is priced at $2,000, and there is no limit of amount of money it receives (RS₆). The transportation can deliver up to 10 tons of goods (RS₇) priced at $1,000 each ton, and there is no limit on the amount of money it receives (RS₈).

With the above assumptions, we have the following qualifying constraints:

For RS₁: 0<=quantity[RS₁,RS₄]<=3 (and no limit on the price)

For RS₂: weight[RS₂, RS₇]=3 (assuming we know 3 truckloads is 3 tons, and no limit on price);

For RS₃: 0<=amount[RS₃, RS₆]<=10000 and 0<=amount[RS₃, RS₈]<=1000.

For RS₄: quantity[RS₁,RS₄]<=100 and price[RS₁, RS₄]=quantity[RS₁, RS₄]*2000.

For RS₆: no restrictions.

For RS₇: weight[RS₂,RS₇]<=10 and price[RS₂,RS₇]=weight[RS₂, RS₇]*1000.

For RS₈: no restriction.

Also, we have the following composition constraints. For each contract variable, we also create an instantiation for each resource as a “summarization”.

For RS₁: quantity[RS₁]=quantity[RS₁,RS₄] and quantity[RS₁]=3 (and no limit on the price)

For RS₂: weight[RS₂]=weight[RS₂, RS₇] and weight[RS₂]=3;

For RS₃: amount[RS₃]=amount[RS₃, RS₆] +amount[RS₃, RS₈] and 0<=amount[RS₃]<=1000.

For RS₄: quantity[RS₄]=quantity[RS₁,RS₄] and quantity[RS₄]<=100 and price[RS₄]=price[RS₁, RS₄]and price[RS₄]=quantity[RS₄]*2000.

For RS₆: no restrictions.

For RS₇: weight[RS₇]=weight[RS₂,RS₇] and weight[RS₇]<=10 and price[RS₇]=price[RS₂,RS₇] and price[RS₇]=weight[RS₇]*1000.

For RS₈: no restrictions.

Note that the above are resource level constraints created from qualifying and composition constraints. There will be business entity level constraints built to capture more restrictions (as explained later). For example, the amount that the vendor is willing to accept (RS₆) must be greater than some price calculation based on the quantity sold (RS₄) with perhaps some discount calculations. Such a constraint that connects resources will be at the business entity level and discussed later.

In the AEO framework, resources are realized with two mechanisms. The first is the Resource Instance (RI) Class and the other is a library of resource models. The concept of a class is similar to that of an abstract data type, which consists of data structure part and an operation (method) part.

The resource instance class contains the following main data elements and methods.

User-Data

Resource-Spec

Build-Qualifying-Constraints()

Build-Composition-Constraints()

Details of the above are described below.

User-Data is the data provided by the user or application. These data is typically used by the Build-Qualifying-Constraints() and Build-Composition-Constraints() methods, for example, to extract values to instantiate parametric coefficients in constraints. User-Data may range from simple to complex. In particular these data may be described in XML format to facilitate data transfer among a variety of heterogeneous systems.

Resource-Spec, as explained in earlier sections, is a static description of a resource used for matching with other resources. It must be an instance of a Resource-Spec class, and is used for matching resource of various business entities (to be discussed in later sections).

Build-Qualifying-Constraints() and Build-Composition-Constraints() methods are used to construct the qualifying and composition constraints of a resource, as described earlier.

There is only one Resource Instance class, so that all resources are represented as objects (or instances) of this class. However, different types of resources may have different qualifying and composition constraints methods. This is exactly the purpose of Resource Models, which provide different definitions of Qualifying and Composition constraints methods. Resource Model attribute in the Resource Instance class indicates which Resource Model, and thus which Qualifying and Composition constraints methods, should be used with the given resource. Various Resource Models are represented as different classes.

The concept of Resources and related notions give us the foundation of the Adaptive Enterprise framework. However, resources belong to business entities and “business” rules relating to these entities exist. For example, a resistor resource and a money resource both belong to a business entity so that if we take the resistors, we should then give money in return. A further example is that a manufacturing department may need to make sure that the purchase (or delivery from the delivery department) of raw materials (input resources) must match (through certain calculations) production of the corresponding products (output resources) and with certain profit margins. Key to describing the “business” rules of a business entity is the notion of BEI constraints, explained next.

The BEI constraints describe the restrictions on the relationships among the input and output resources in the BEI. For example, business entity may decide that the total price agreed on input resources must be equal to the total amount of money paid (the output resource). Other aspects of the BEI constraints include some “negotiable parameters” at the business entity level. For example, the total price of the output resources may be subject to some total (monetary) volume discount. Furthermore, BEI constraints may define some additional business metrics, connect them to resources, and impose restrictions. For example, profit variable can be defined as revenue minus costs, revenue as the summation of all input monetary resource amounts, costs as summation of all output monetary resource amounts, and then restriction can be made that profit should be at least 7%.

Business entities in the AEO framework are realized by a BEI class and a library of business models, which are described below.

The BEI class contains the following main attributes and methods:

User Data

BEI Specification

Get Input Resources()

Get Output Resources()

Build BEI Constraints()

Validate User Data()

Validate Result()

Build Result View()

Details of the above are as follows: User-Data is the data provided by the user or application. These data is typically used by the Build BEI Constraints methods, for example, to extract values that instantiate parametric coefficients in constraints, as well as additional information to be used by other BEI methods. User-Data may range from simple to complex. In particular, these data may be described in XML format to facilitate data transfer among a variety of heterogeneous systems.

BEI specifications is used to match BEI's similar to the way RI specifications are used to match RI's. Matching BEI's, which described in more detail in the Decisions section, is used to describe the allowed resource flow in the enterprise or a value chain, so that output resources could match input resources only if they adhere to the allowed flow among the BEI's. BEI specifications are typically described using attribute-value pairs.

Get Input Resources() is a method that extract input RI's from the User Data. Input resources of the BEI are those that the business entity “consumes” for its operation.

Get Output Resources() is a method that extract input RI's from the User Data. Input resources of the BEI are those that the business entity “produces” in its operation.

Build BEI Constraints is a method that constructs specific BEI constraints based on User Data.

Validate User Data() is an optional method that allows to validate certain known restrictions that User Data must satisfy.

Build Result View() is an optional method that extracts a partial result or a view from the results of AEO. Results of AEO provide recommended values for all constraint variables in the enterprise, including variables relevant to the considered BEI. The idea is that the user at the business entity level may want to know only a small portion of the overall optimization results that is relevant to her business entity.

As for the resources, there is only one Business Entity Instance (BEI) class, so that all business entities are represented as objects (or instances) of this class. However, different types business entities may have different constraint building and other methods. This is exactly the purpose of Business Entity Models (BEM), which provide different definitions of BEI constraints and other methods. The BEM attribute in the Resource Instance class indicates which BEM, and thus which constraints methods, should be used with the given BEI. Various Resource Models are represented as different classes.

A decision instance is a formal description of an enterprise-level decision/optimization problem. It specifies the following aspects of the decision/optimization problem:

The business entities that participate in the decision/optimization problem, including the match ups of the BEIs (i.e., the match of the input resources of a BEI against the output resources of another BEI)

The objective function of the decision/optimization problem

The resource-level restriction/condition for all the resources participating in the decision/optimization problem

The specification of subproblems

The output specification

We now explain each aspect in more details.

A decision instance includes two mechanisms to specify the participating BEIs and the match up of resources among the participating BEIs. The first is the anchor BEIs method that is to specify certain business entities as the “starting” points of an optimization/decision problem. For example, we may specify, for a particular optimization problem in a power company, the starting point is a particular generating unit. This generating unit will be our anchor BEI. The generating unit will require resources that are coming from different business entities in the enterprise, but they are not what we call the anchor BE. We use a filtering method associated with the DM to find the anchor BEs. This method is a flexible mechanism that allows the DM to decide anchor BEs.

The second mechanism is the MatchBEI method that specifies the match up of the BEIs at the BEI level. In addition, the resource level matches (described earlier) also decide which BEI will participate in the problem.

In general, a BEI participates in the optimization/decision problem if it is an anchor BEI (given by the anchorBEI method) or it matches, directly or indirectly, an anchor BEI, described as follows.

The match of BEI consists of two levels. The first is the BEI level that is done through the MatchBEI method. The input to the MatchBEI method is two BEIs and the output is true or false. A “true” output means that the DM decides that the two input BEIs have a match, and “false” means no match. In addition, for each pair of BEIs that match, output resources of the first BEI and the input resources of the second BEI are examined. The participating resources decide whether an output resource (of the first BEI) matches an input resource (of the second BEI). This decision is by the resource level match method (i.e., the is-Output-Input-Match method). Now, two BEIs match if they match based on the MatchBEI method and at the same time, at least one output resource of the first BEI matches at least one input resource of the second BEI.

From the above two mechanisms, a match map can be constructed. The match map is similar to a directed graph if each BEI is viewed as a node. For each pair of matching BEIs, the match map shows the resource match up of the BEIs. The match map initially consists of only the anchor BEIs. The matches among anchor BEIs are first considered, and resource matches are added to the match map. Then other BEIs are considered. If a BEI matches those already in the match map (initially only the anchor BEIs), then the BEI is added to the match map and the resource matches are added. This process is recursively carried out until no other BEIs match any already in the match map.

All the BEIs appear in the above match map are those participating in the optimization/decision problem, and the match map also shows the matching resources.

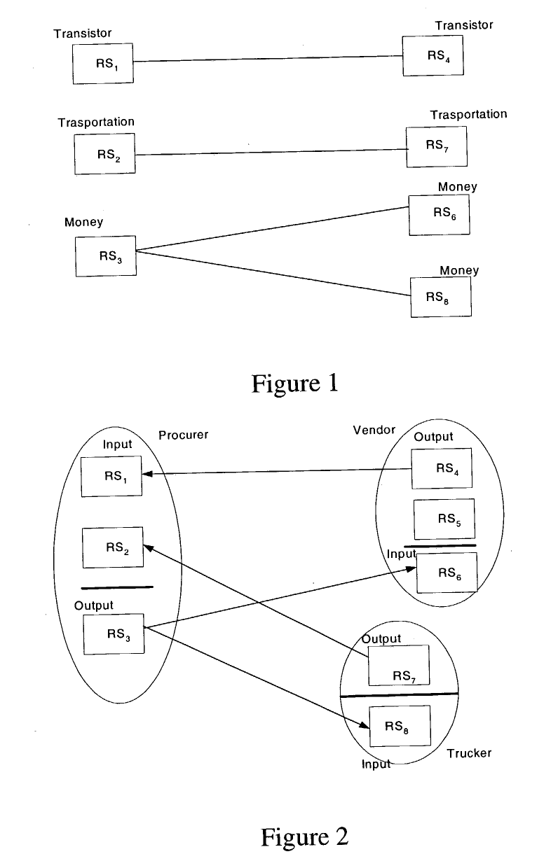

As an example, FIG. 2 shows three BEIs, namely one for the procurer, one for a vendor and one for a trucker. In this example, the anchor BEI might be the procurer. The procurer BEI in its matching specification may indicate that the vendor and the trucker must meet certain requirements such as “number of years in business”, while the vendor and trucker BEIs may require that the procurer to meet certain other requirements such as “credit rating”. FIG. 2 shows the matching vendor and trucker for the procurer. In this case, all the non-anchor BEIs (vendor and trucker BEIs) directly match the anchor BEI (procurer BEI). Note that in this scenario, procurer BEI matches vendor BEI, and at the same time (since matching is ordered), vendor BEI matches the procurer BEI. Likewise, the matching of procurer BEI and trucker BEI is bi-directional.

In general, the semantics of a BE, when participating in a trade derived from a match map, is that its BE-level constraint, and the qualifying and composition constraints of all its resources must be satisfied.

If each resource in all the BEs matches at least one other resource, then the above is well defined. The situation is slightly more complicated if a resource does not match a resource in the match map. In this case, the qualifying and composition constraints for the unmatched resources are created as follows.

By definition, qualifying constraints are built for each link (or pair of resources that match in the match map). Therefore, if a resource does not have any matching resources, then the qualifying constraint for the resource is not built. For composition constraints, even if there are no matching resources, we still need to build them for the resources; the building method simply takes the empty set for its matching set of resources as the input. This semantics is determined by the concept of BE due to its intended nature that all the resources in the BE are involved. However, for certain applications, we may skip this step for unmatched resources by using application specific semantics.

Now that we have defined the constraints from BEs and their resources, we may now go ahead to construct the constraint for a match map. The constraint generated intuitively corresponds to the conjunction of all the qualifying constraints of all the resources and composition of constraints of all the resources as well as the BE-level constraints of all the involved BEs. The use of conjunction as the connective means that all the constraints generated from each BE and its resources must be satisfied. This is intuitively correct because we want to satisfy all the constraints of all the participants of the trade.

The generation of resource-level constraints is described elsewhere. We only need to be careful of the resources that do not match any resources: qualifying constraints are not built for them, but composition constraints are still built (with empty resource set as input).

In many practical cases, if a resource in a BE does not have a match, we may simply ignore the composition constraint for the resource. For example, a BE may be the catalog of a vendor that consists of a large number of resources and any subset of the resources can be traded with procurers. In this case, if no procurer resources match a catalog resource, we may be able to safely ignore this catalog resource for the purpose of this particular trade. Whether we can ignore the resource in the trade depends on the composition constraint built in case of the empty matching resource set.

Theoretically, this amounts to the following condition when an resource can be safely ignored in a trade: the two constraints, one built with the composition constraint for the resources without matches and the other built without considering these resources, are equivalent (i.e., yield the same solutions).

For example, if the composition constraint is formed as “the sum of the quantities is greater than or equal to 0”, then the composition constraint built with no matching resources is “0>=0” (since the sum of the empty set is “0”). Clearly, this constraint is always satisfiable and can be safely discarded without changing the overall constraint (which is a conjunction of all the involved qualifying, composition and BE-level constraints). Hence this resource can be ignored.

As another example, if the composition constraint is that “the sum of the quantities is exactly 10” (this is the case when we want to purchase exactly 10 pieces of the resource), then the composition constraint built with the empty set will be “0==10”, which is always false. Hence, if this resource does not have a match, then there is no solution to the overall constraint, and no trade can be done satisfying all the constraints.

In practice, the above criterion is easily verified and “pre-computed”. Hence, one may associate with each resource in a BE as a flag indicating whether the resource is “optional” or “required”. If the resource is labeled “optional”, it will mean that the above theoretical condition is guaranteed to be true by the owner of the BE, and hence if no resource matches an optional resource, the optional resource can be safely ignored. If the resource is required, then the resource must have a match.

Note that in the above “flag” implementation description, we skipped the case when an resource's composition constraint (with empty matching resource set) does not always lead to a contradiction. In this case, we will have to include the composition constraint in the overall constraint. We may introduce another “flag” such as “optional-with-constraint”, which indicates that the resource may not have matching resources, but the composition constraint should be included in the overall constraint nonetheless.

The decision model also specifies a trading objective, which consists of two parts. The first is maximize/minimize flag, and the second is a method that generates an objective function. The maximize/minimize flag indicates whether the values of the objective function should be maximized or minimized. The objective function is built over all the contract variables that are generated for the resources of the anchor BEs. For example, in FIG. 2, since the anchor BEI is the procurer BEI, the objective function may be built over its resources. An example function is simply “amount[R3]” with minimization as the objective.

Sometime the whole match map may need to be partitioned into smaller match maps. For example, the decision problem stipulates that only one anchor BE (and all the BEs that directly or indirectly match it) should be considered at a time, although many anchor BEs are specified. In this case, this subproblem definition will specify how these sub-match maps are generated.

The method GetPartialMatchMaps() is used for the generation of partial match maps. The input of this method is a (whole) match map and the output is a set of (partial) match maps.

For each partial match map, the constraint building procedure is the same as the one for the whole. The objective function is also built for each partial match map. The overall semantics of the problem (with partial match map) is to maximize/minimize (depending on the flag in the objective of the DI) the value of the objective functions (over all the partial match maps). Note that when there is only one partial match map, the case is exactly the same as the semantics for the whole match map.

The output specification is a mechanism that takes solution to the optimization problem, and reformulates it into user-specified format.

The above section described the basic infrastructure of the AEO optimization. There are two methods that are convenient for users. The first is to construct additional constraint from the decision instance perspective, and the other is for the selection of subsets of the resources for the optimization problem.

There is an additional method that creates additional constraints for the decision instance. This is a method that examines all the BEs and their resources that participate in the match map and creates a constraint.

The decision model also includes a condition on the resources that participate in the decision problem. That is, not all resources may participate in the problem. The restriction/constraint specifies what resources are allowed.

Just as the business entities, AEO framework uses a Decision Instance (DI) class and a library of decision models to realize the decision instances.

The decision instance class contains the following main attributes and methods:

User Data

Get Anchor Specification()

Match BEI(BEI, BEI)

Build Master Match Map(BEI Pool)

Get Partial Match Maps()

Build DI Constraints(MatchMap)

Build Objective Function(MatchMap)

Optimize(MatchMap)

Validate DI Data()

Validate Results()

Build Result View()

The User Data part will allow certain data values to be inserted so that all the methods, such as match BEI, objective function, partial match map, can use to generate a particular instance. GetAnchorSpecification method is used to retrieve anchor BEIs, matchBEI is to decide whether two BEIs match, buildMasterMatchMap is the method that generates the match map from the anchor BEIs. GetPartialMatchMaps is the method to general subproblems. BuildDIConstraints is to add additional constraints, and BuildObjectiveFunction is to build the objective function. Optimize is the method to call to get optimized solution to the optimization problem generated. There are two validation methods, validateDIData and validateResults are to guide again corrupt data, and finally, buildresultView method is to generate the results from the optimized solution to the user.

There is one class for all the decision instances as above. To realize different decision instances, a library of decision models can be set up in the AEO framework. Each instance of the DI class has a corresponding decision model.

We are now ready describe the overall flow of the decision problem from a (conceptual) operational perspective. The decision/optimization problem starts with a decision instance.

1. The anchor BEIs are found (specified by the anchor BEI method)

2. All BEIs are examined to see if they match (BEImatch method) any anchor BEI or any BEI that already match an achorBEI, recursively.

3. For each (ordered) matching pair of BEIs, the output resources of the first BEI is matched against the input resources of the second BEI (using RMS matching method). The resources used in this matching step are filtered through the resourceLevelFilter method in the decision instance.

4. From the above, a match map is generated.

5. The Get_partial_matchmap method is used to generate (if any) partial match maps.

6. Optimization algorithms are used on the match map and partial match maps to generate optimized solutions.

7. The result of the optimization is delivered to the user through the build_result_view method.

In this section, we give two complete examples of AEO decision problem, including the resources, business entities and the decision instances. The first example concerns a purchase of goods from a vendor and at the same time the transportation of the goods. The goal is to minimize the procurement cost. The second example is a supply-chain scenario with objective of maximizing profits for the overall process.

This is a summary of the example we used for resource match scenario and match map. In this example, we have three BEMs, one for procurers, one for vendors, and one for truckers. We assume three RMSs: transistor, Transportation, and Money.

The DM is set up to have the following components. The Anchor BE is a Procurer BE. That is, the decision model needs to select a Procurer BE to be the anchor. Intuitively, this corresponds to the situation where we want to make a decision for the procurer on what and where to buy goods and services. The Matching Specification states that the Procurer BE will try to match all Vendor BEs and all Trucker BEs. Whether a Vendor BE and a Trucker BE will participate in the decision is based on whether if the Vendor BE and the Trucker BE have resources matching those in the Procurer BE.

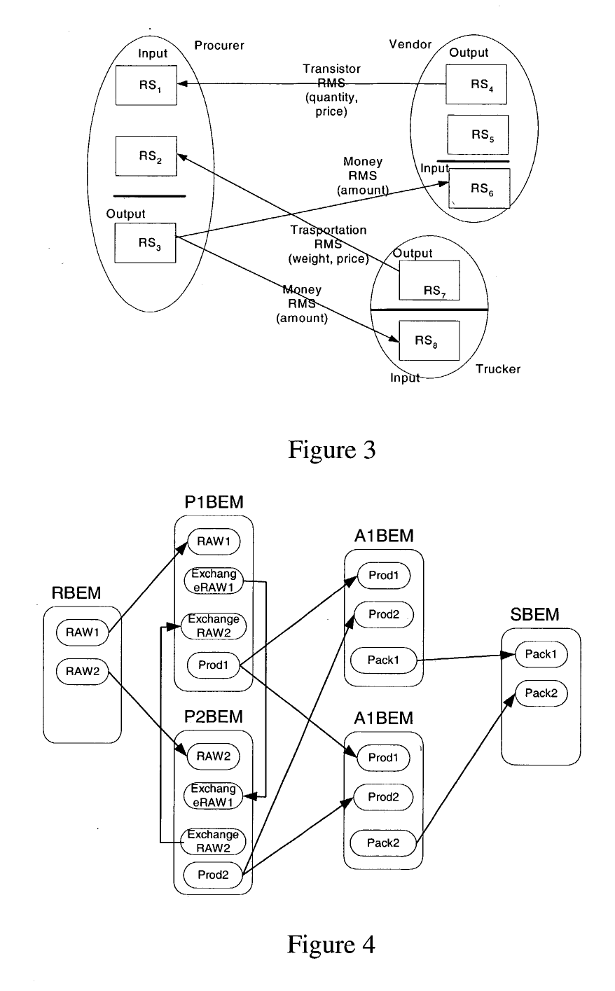

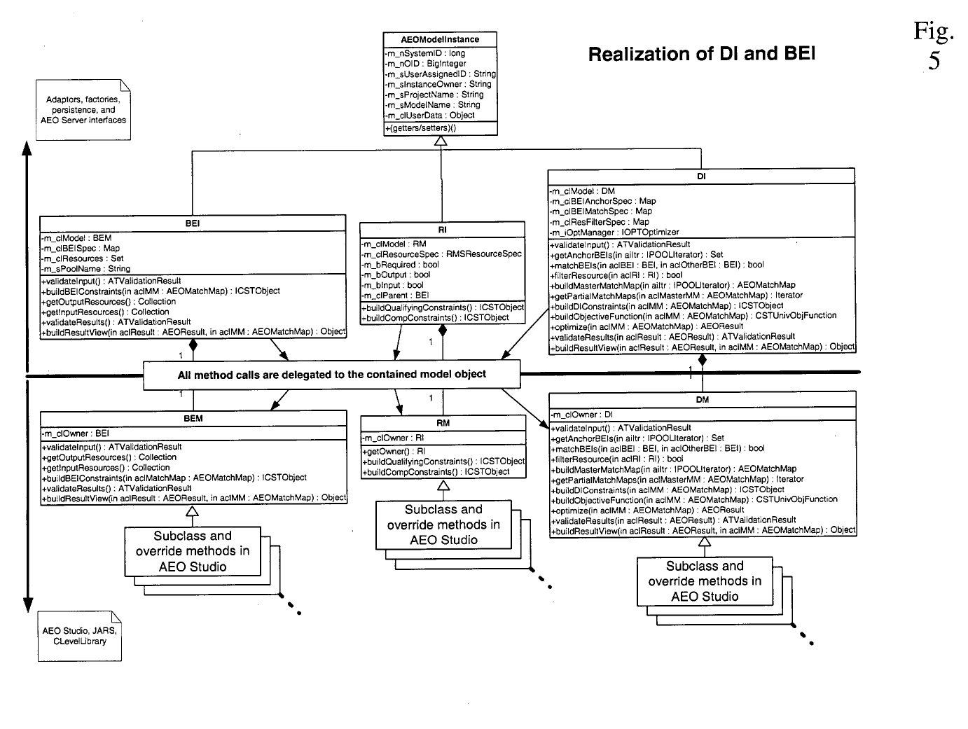

As an example, FIG. 3 shows a match map with contract variables. We assume in this DM, the objective function is to minimize the overall amount of money resource that needs to output from the procurer. Also, we can assume that Subproblems of this DM will specify all possible combinations of any one or more vendors and any one or more truckers if there are more than one vendors and trucker.

The other parts of the DM, namely Resource-level restrictions, optimization algorithm, and output specification, are omitted from this example.

In the above scenario, since there is only one vendor and one trucker, we only have one problem from the subproblem generator.

The constraints the server generates from the match map will be:

Qualifying constraints (QRSᵢ is the qualifying constraint for RSᵢ):

QRS₁ with contract variables quantity[RS₁,RS₄], price[RS₁,RS₄]

QRS₂ with contract variables weight[RS₂,RS₇], price[RS₂,RS₇]

QRS₃ with contract variable amount[RS₃,RS₆]

QRS₃ with contract variable amount[RS₃,RS₈] (QRS₃ appears twice because RS₃ matches with two items RS₆ and RS₈, respectively. Also note that there is no qualifying constraint for RS₅ since it does not match any item in the match map.)

QRS₄ with contract variables quantity[RS₁,RS₄], price[RS₁,RS₄]

QRS₆ with contract variable amount[RS₃,RS₆]

QRS₇ with contract variables weight[RS₂,RS₇] and price[RS₂,RS₇]

QRS₈ with contract variable amount[RS₃,RS₈]

Composition constraints (CRSᵢ is the composition constraint for RSᵢ) (Unlike the qualifying constraints, exactly one copy of the composition constraint appears for each item.):

CRS1 with contract variables quantity[RS₁,RS₄], price[RS₁,RS₄]

CRS2 with contract variables weight[RS₂,RS₇], price[RS₂,RS₇]

CRS3 with contract variables amount[RS₃,RS₆], amount[RS₃,RS₈]

CRS4 with contract variables quantity[RS₁,RS₄], price[RS₁,RS₄]

CRS5 with no contract variables

CRS6 with contract variable amount[RS₃,RS₆]

CRS7 with contract variables weight[RS₂,RS₇] and price[RS₂,RS₇]

CRS8 with contract variable amount[RS₃,RS₈]

At the BE level, the following constraints are built: For the procurer BE, the constraint uses the contract variables: quantity[RS₁,RS₄], price[RS₁,RS₄], weight[RS₂,RS₇], price[RS₂,RS₇], amount[RS₃,RS₆], amount[RS₃,RS₈] (i.e., all the contract variables that appear in the qualifying and composition constraints for the items in the procurer BE). For the vendor BE, the constrain uses the contract variables: quantity[RS₁,RS₄], price[RS₁,RS₄], amount[RS₃,RS₆]. For the trucker BE, the constraint uses the contract variables: weight[RS₂,RS₇] and price[RS₂,RS₇], amount[RS₃,RS₈].

In a supply-chain example, we look at an example that involves raw materials, production lines, assembly lines, and sales department. We will first set up the required Resource Models, and BEM for each business entity, and give an example of the corresponding BEI. After these, we will give the DM and corresponding DI, and as well as all the steps that are involved in the AEO server.

There are only two kinds of resources, namely raw material and products. Both can be modeled in a single RMS, which we call SCR (short for Supply-Chain Resource). An SCR has four attributes, (1) name, (2) minquantity, (3) maxquantity and (4) timestamp.

Resource matches: At the resource level, two resources match if they have the same name, and the same timestamp.

Contract variable: The contract variable for SCR is only “varQuantity”.

Local variable: For each resource, there is a local variable named “totalQuantity”.

Qualifying constraint: The qualifying constraint is 0<=varQuantity <=maxquantity Composition constraint: minquantity<=totalQuantity<=maxquantity and totalQuantity=Sum( varQuantity from all the matching output ones)−Sum(varQuantity from all the matching input ones)

Note that the total quantity can be negative, meaning that the involved BE needs to produce for that much to satisfy the overall problem. If the total quantity is positive, then the BE may use its purposes (e.g., to produce other resources).

Examples of BEMs will now be set forth.

The raw-material BEM (RBEM) is a simple BEM. It involves the SCR resources. It has a BE-level variable named varcost. We assume there is a function that relates the totoalQuantities of all the involved SCR resources with the varCost: varcost=fcost(totalQuantity_{—}1, . . . , totalQuantity_n).

For simplicity, assume there are only two types of raw materials, RAW1 and RAW2. That is, the name attribute of the SCR is either RAW1 or RAW2 in an RBEM.

The production line 1 BEM (P1BEM) contains four types of SCR resources.

RAW1

ExchangeRAW1

ExchangeRAW2

Product1

RAW1 and ExchangeRAW2 are input resources, and ExchangeRAW1 and Product1 are output resources.

The BEM level constraint: totalQuantities of (RAW1−ExchangeRAW1) and that of ExchangeRAW2 will generate (through a function) the totalQuantities of Product1

The production line 2 BEM (P2BEM) contains three types of SCR resources.

RAW2

ExchangeRAW1

ExchangeRAW2

Product2

each other, and production BEs will match assembly BEs, and Assembly BEs will match Sales BE. The above “match” is directional, i.e., if BE1 match BE2, then only the output resources of BE1 will match the input resources of BE2 (the resource matching is via the names of the SCR resources).

The objective function is varCost of RBEM minus varRevenue of SBEM.

At each BE, each resource type may have a lot of copies, each having a different timestamp. The resourceLevelFilter will be stating which range of timestamps will be considered for the decision problem.

The subMatchMap method will be able to pick up one assembly BEM at a time for the optimization, and both at the same time. Hence, there will be three match maps as the result of subMatchMap method.

The optimization algorithm in this case will be standard LP if all the functions involved are linear functions.

Two specific resource specifications will be disclosed. The AEO server framework also includes the methods of resource specifications and resource matching specifications. These can be flexibly extended in our framework. But there are two built-in resource-matching specifications (RMS) that are general to many applications. These are exact match and more-general-more-specific specifications.

A resource may be described by an exact-match specification. It consists of three parts, namely required-of-other, required-by-other, and attribute-value. Each part is a set. The required-of-other part is a set of attribute names, the required-by-other part is a set of attribute-value pairs, and the attribute-value part is a set of attribute-value pairs as well.

Two resources match if their resource match specs match. In the exact match case, it means the following:

1. If an attribute appears in the required-of part of one resource, then the other resource must have an attribute-value pair in the required-by part such that the attribute name in the pair is exactly the attribute name from the first resource. This must be true for each attribute in the required-of part of each of the two resources.

2. If an attribute value pair appears in the attribute-value part of a resource, the same pair must also appear in the attribute-value part of the other resource.

As an example, assume we have two resources R1 and R2 whose exact match specs are given as follows:

RS₁: required-of-other={resistance-rating}, required-by-other={}, attribute-value ={(UPS, 1000)}

RS₂: required-of-other={}, required-by-other={(resistance-rating, 10)}, attribute-value ={UPS, 1000)}.

It is easily seen that these two resources RS₁ and RS₂ do match.

A resource may be described by a more-general-more-specific specification. The specification consists of only one set of attribute-value pair. However, the matching description is more sophisticated and is motivated by catalog searching kind of applications.

If the exact match specifications are used, two matching resources do not have an order. That is, if one resource matches the other, then vise versa. However, if more-general-more-specific specification is used, then the order is important. A resource R₁ matches a resource R₂ in one of the two ways, more general or more specific or both.

1. R₁ is more general than R₂ if for each attribute-value pair (A, v₁) in R₁, there must be an attribute-value pair (A, v₂), with the same attribute name A, appearing in R₂, and the value v₂ is “more general” than v₁. Here whether a value is more general than the other depends on the data type. If the data type is a scalar, i.e., a string, an integer or a real, then it is required that v₁=v₂. If v₁ and v₂ are two sets (such as two intervals of reals), then v₁ is more general than v₂ if v₁ is a superset of v₂.

2. R₁ is more specific than R₂ if R₂ is more general than R₁.

It is possible that R₁ is both more general and more specific than R₂. In this case, the specifications of R₁ and R₂ are actually the same.

As mentioned earlier, this more-general-more-specific specification is motivated by catalog search applications. Indeed, we describe the following example. Assume we have two resources R₁ and R₂, one is an input resource for a procurer, and the other output resource for a supplier.

R₁={(type, resistor), (resistance, [10, 15]) }, i.e., the procurer wants to buy a resistor with the resistance falls into the range of 10 to 15 (inclusive).

R₂={(type, resistor), (resistance, [12,12]), (color, red)}

In this case, R₁ is more general than R₂. Indeed, for each attribute-value pair of R₁, R₂ has a more general pair. Intuitively, R₁ gives a general description of the product the procurer wants to buy, and R₂ gives a specific product that the supplier has to offer. Hence, R₁ is more general than R₂, or R₂ is more specific than R₁.

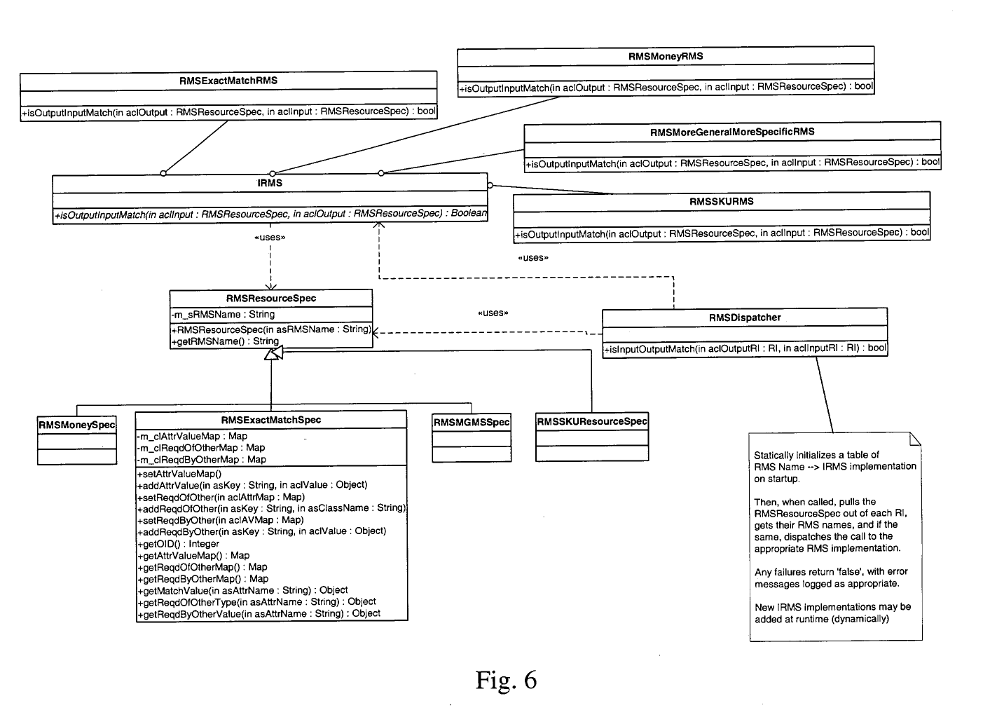

FIGS. 5 and 6 show the class diagrams of the AEO framework. All the components have been described above.

While a preferred embodiment of the present invention has been set forth above, those skilled in the art who have reviewed the specification will readily apprciate that other embodiments can be realized within the scope of the invention. For example, the present invention can be implemented on any suitable computer hardware, using any suitable programming language. The invention can also be implemented over the Internet, over any other network, or on a stand-alone machine. Moreover, the business entities are not limited to separate companies, nor are the business decisions limited to transactions. For example, the business entities can be stages in a pipeline, and the business decisions can control the interaction among the various stages. Therefore, the present invention should be construed as limited only by the appended claims.

We claim:

1. A method for determining an optimal business decision regarding a plurality of business entities, the method comprising:
(a) providing, in a computing device, a plurality of business entity instances, each representing one of the plurality of business entities and including an identification of at least one output resource that the business entity wishes to give, at least one input resource that the business entity wishes to take, and at least one constraint that the business entity places on the business decision;
(b) determining, in the computing device, matching pairs of the business entity instances, such that in each of the matching pairs, (i) each of the business entity instances satisfies the at least one constraint placed by the other business entity instance and (ii) an output resource of one of the business entity instances matches an input resource of the other one of the business entity instances;
(c) constructing, in the computing device, a match map of all of the matching pairs determined in step (b);
(d) specifying, in the computing device, an optimization objective function comprising an objective function and an indication of whether the objective function is to be maximized or minimized;
(e) determining, in the computing device, the optimal business decision as a business decision within the match map which optimizes the objective function; and
(f) presenting the optimal business decision to a user.

2. The method of claim 1, wherein at least one of the business entity instances is identified as an anchor business entity instance, and wherein the objective function is determined with respect to the at least one anchor business entity instance.

3. The method of claim 2, wherein step (b) comprises:
(i) determining matching pairs that include the at least one anchor business entity instance;
(ii) determining matching pairs that include a business entity instance that is already included in at least one matching pair; and
(iii) recursively performing step (b)(ii) until all of the matching pairs have been determined.

4. The method of claim 1, wherein step (e) comprises:
(i) dividing the match map into a plurality of partial match maps;
(ii) optimizing the objective function within each of the partial match maps; and
(iii) from the objective function optimized within each of the partial match maps, selecting a globally optimized decision.

5. The method of claim 4, wherein step (e)(ii) comprises:
(A) constructing global constraints for the partial match map by forming a conjunction of business-entity-level constraints for all business entity instances in the partial match map, composition constraints for each resource within the partial match map, and all the qualifying constraints for each pair of matching resources in the partial match map;
(B) adding the objective function to the global constraints; and
(C) optimizing the objective function subject to the global constraints using an external optimization solver.

6. A method for determining matches among a plurality of resources associated with a plurality of business entities, the method comprising:
(a) providing, in a computing device, a resource specification for each of the plurality of resources, each resource specification identifying the resource, one of the plurality of business entities associated with the resource, an identification of a class to which the resource belongs from among a plurality of classes, and an identification of whether the resource is an output resource that the business entity is willing to give or an input resource that the business entity is willing to take;
(b) providing, in the computing device, a matching criterion for each of the plurality of classes;
(c) determining, in the computing device, for two resource specifications to be matched, whether one of the resource specifications identifies an input resource and whether the other of the resource specifications identifies an output resource;
(d) determining, in the computing device, whether the two resource specifications identify the same class;
(e) if steps (c) and (d) return TRUE results, determining, in the computing device, whether the input resource and the output resource match, using the matching criterion for said same class;
(f) if all of steps (c), (d) and (e) return TRUE results, determining, in the computing device, that the resource specifications to be matched match; and
(g) if any of steps (c), (d) and (e) returns a FALSE result, determining that the resource specifications to be matched do not match.

7. The method of claim 6, wherein the plurality of classes comprises an exact-match class, and the matching criterion for the exact-match class requires an exact match between an attribute of one of the resources and either an attribute or a requirement of the other of the resources.

8. The method of claim 6, wherein the plurality of classes comprises a more-general-more-specific class, and the matching criterion for the more-general-more-specific class requires that an attribute of one of the resources be within a set or range of attributes required by the other of the resources.

9. A method of forming a business entity instance that represents a business entity, the method comprising:
(a) receiving, in a computing device, user data representing the business entity;
(b) from the user data, determining, in the computing device, (i) at least one business enterprise instance specification identifying an allowed resource flow in the business entity, (ii) at least one input resource instance representing an input resource that the business entity is willing to take, (iii) at least one output resource instance representing an output resource that the business entity is willing to give, and (iv) at least one constraint representing a required relation between the at least one input resource and the at least one output resource; and
(c) forming, in the computing device, the business enterprise instance in accordance with the at least one business enterprise instance specification, the at least one input resource instance, the at least one output resource instance, and the at least one constraint.

10. The method of claim 9, wherein step (a) comprises:
(i) storing a predetermined criterion to be satisfied by the user data; and
(ii) validating the user data in accordance with the predetermined criterion.

11. The method of claim 9, further comprising:
(d) extracting, in the computing device, a partial view of the business enterprise instance; and
(e) presenting the partial view to a user.

12. The method of claim 9, wherein:
the user data comprise an indication of a class, from among a plurality of classes, to which the business enterprise belongs;
the computing device stores a plurality of business enterprise models, each representing a set of constraint building methods for one of the classes; and
step (b) is performed in accordance with the set of constraint building methods for the class to which the business enterprise belongs.

13. The method of claim 12, wherein the plurality of classes comprise a class of suppliers of raw materials, in which the output resource is a raw material and the input resource is payment for the raw material.

14. The method of claim 12, wherein the plurality of classes comprise a class of production-line enterprises, in which the input resources are a raw material and payment for a product, the output resources comprise payment for the raw material and the product, and the set of constraint building methods comprises a method for building a constraint ensuring that a desired quantity of the product can be produced.

15. The method of claim 12, wherein the plurality of classes comprise a class of assembly-line enterprises, in which the input resources comprise a plurality of products and the output resources comprise a package, and the set of constraint building methods comprises a method for building a constraint ensuring that a desired quantity of the package can be produced.

16. The method of claim 12, wherein the plurality of classes comprise a class of sales enterprises, in which the input and output resources comprise packages, and the set of constraint building methods comprises a method for building a constraint linking quantities of the packages of the input and output constraints.
